(19) United States
(12) Patent Application Publication
(10) Pub. No.: US 2011/0055849 A1
(43) Pub. Date: Mar. 3, 2011

(54) METHOD FOR CONTROLLING AN INTERACTION BETWEEN MODULES OF A SERVICE-ORIENTED COMPONENT AS WELL AS A SERVICE-ORIENTED COMPONENT

(75) Inventors: Armando Walter Colombo, Karlstein (DE); Joao Marco Mendes, Ponte de Lima (PT)

(73) Assignee: SCHNEIDER ELECTRIC AUTOMATION GMBH, Seligenstadt (DE)

(21) Appl. No.: 12/919,506

(22) PCT Filed: Feb. 27, 2009
(86) PCT No.: PCT/EP2009/052421

§ 371 Date: Oct. 27, 2010

(30) Foreign Application Priority Data
Feb. 29, 2008 (DE) 10 2008 002 785.5

(51) Int. Cl. G06F 9/46; G06F 3/00

(52) U.S. Cl. 719/313; 719/318

(57) ABSTRACT

A method for controlling interaction between modules such as a communication module (KOM-MOD), control module (LC-MOD), device-interface module (GI-MOD) of a service oriented component (SOK). According to the invention, in order to simplify the interaction between modules during different and concurrent processes, the interaction between the modules (KOM-MOD; LC-MOD; GI-MOD) is event based and the modules (KOM-MOD; LC-MOD; GI-MOD) are coupled by an event-router scheduler module (EAS-MOD) for providing an event-router-scheduler for event-based connections and synchronisation of the module (KOM-MOD; LC-MOD; GI-MOD).

The invention relates to a method for controlling an interaction between modules such as communication module, control module, device interface module of a service-oriented component; to a service-oriented component such as an automation device; as well as to a software component.

Production and automation systems are by nature heterogeneous and consist of different components depending on their tasks. It is therefore foreseeable that the specifications of such systems will develop away from the traditional, centrally controlled approach towards a distributed corresponding approach that adapts itself to the natural conditions and to the layout of the real system.

It is therefore promising to have a collection of distributed, autonomous, intelligent, error-tolerant and reusable manufacturing units that collaborate as a set of cooperating units. Each unit is capable of interacting with each of the others in order to attain local as well as global production objectives, from the physical machine control level at the manufacturing site to higher levels of the plant management system. This new generation of systems is called intelligent manufacturing systems (IMS).

One of the emerging solutions for adapting the multitude of concepts behind IMS to usable principles is the service-oriented architecture (SOA). The SOA concept has attained great significance in just a few years and will doubtless have a great impact in many technology sectors. A service-oriented architecture is a set of architectural theorems for the construction of autonomous and interoperable systems. This assumption points up one of the challenges of IMS, namely the provision of interoperability between autonomous systems.

The adaptation of the service-oriented concept to automation and manufacturing “business systems” at the manufacturing site under observation of the principles of IMS will generate a new “community” made up of service-oriented automation components. Each participant in the system is designated as a service-oriented component and in some expansions as a service-oriented automation component, if the component is equipped with automatic control units. Components may perform various tasks such as, for example, manufacture, transport or monitoring, and may be operated autonomously. Since services take over the actual guidance, these components should have the capability to request services and, conversely, to support the requests for services by other participants of the community. Services themselves are a form of provision of resources and actions that are shared under certain circumstances, very similar to services in real life.

In the case of distributed automation, and in particular in the area of manufacturing systems, a set of pieces of equipment and additional components of the system may, under certain circumstances, be compared to a community of “living things”. If one examines a component more closely, its internal mechatronic rganization may be compared to functional organs that are responsible for specific tasks that provide “live” properties that are capable of fulfilling such tasks. A central question is how these functional modules or “organs” are integrated and controlled and capable of exchanging events among themselves, thereby forming complex and effective structures.

Service-oriented systems are one approach for specifying the environment for heterogeneous “organisms” that require interaction. Service business systems have been known in the world of business and electronic commerce; in the area of industrial automation and manufacturing system (in particular concerning distributed devices) it is a relatively new research sector with promising perspectives. An important starting point was the SIREANA research project of the EU whose objective it was to develop a service infrastructure for integrated real-time network applications. The implementation of a service framework was developed in accordance with the “device profile forward services (DPWS)” specifications in order to facilitate the communication between resource-dependent integrated devices.

An important point of this system is the arrangement of the control and how its granularity and distribution is influenced. Since the introduction of common programmable logic controllers (PLC), significant progress has been made in research and development with the objective of overcoming the restrictions with regard to the centralized use of PLCs. Proposals have been submitted from the areas of multi-agent systems, holonic systems and, recently, service-oriented systems.

Architectures for devices and control software have also been in the field of vision of research, usually using ICE 61131-3 languages, the IEC61499 function blocks for distributed control and automation and other control technologies such as Petri nets. For devices distributed in service-oriented fashion, the control procedure is partially open to any control approach; however, it should also take specific requirements of service orientation into account.

By offering various functionalities, an individual service-oriented control device should be ready for various activities; it therefore requires a specially adapted internal frame structure or a programming scaffolding, hereinafter called framework, that can handle the various and competing processes.

Starting therefrom, the objective of the invention at hand is to continue the development of a method as well as of a service-oriented component and a software component of the type mentioned at the beginning in such a way that the interaction between modules is simplified in the case of different and competing processes.

The objective is met in accordance with the invention through the fact that the interaction between the modules occurs in event-based fashion, with the event-based interaction between the modules and the synchronization of the modules being controlled via an event router scheduler.

An event router scheduler is provided for the event-based connection and synchronization of functional modules in service-oriented components, devices and supporting applications.

The latter can be integrated into modular service-oriented components that, for example, support distributed automation devices, and provide a framework for the communication between the functional modules forming a component. The application relates in particular to automation devices for manufacturing sites and supporting software applications.

A service-oriented component is a modular structure composed of various functional modules including the central event router and the required service-oriented communication module that has the capability of facilitating the communication with other components. Since the component is a multi-threading-capable environment and requires data protection, a mechanism must be in place for these tasks that provides the individual modules with an interaction environment.

The invention makes it possible for the communication of automation control component modules to occur only in the case of events. This is helpful in order to control the real-time synchronization of these modules and the data transcription protection. Thus, each module becomes independent but complementary. The approach permits the developers to program each module independently and to know in a simple manner how the information received is to be processed.

If the control component is made up of several modules that act asynchronously and that can use various processes and/or threads, a special module will be required in order to connect all modules with each other and to maintain data concurrency. To this end, the “heart” of the puzzle is the event router scheduler module that makes the following main characteristics available:
it permits an event transfer between each module which allows a complex interaction mechanism to use simple basic functions;
joint event router scheduler mechanism for integrated functional modules;
prioritized buffers for events in the case of high event volumes;
thread management and data protection equipments;
general interface in order to attach various types of module.

Real-time applications are getting more and more complex on a daily basis. In particular, applications of machine controls are created to handle electronic components in order to send information to a supervisor computer such as personal computers in order to communicate with other controls, and so on. The processing of the entire flow of information can be very complex; moreover, errors, years-long developments or frequent equipment reprogramming are to be avoided in industrial automation.

The application provides the following advantages:
The event router scheduler makes an internal event-controlled architectural frame available through which the flow of information for interconnected functional module is controlled.
Simpler functional module definition/separation and integration into the components through the use of the central event router scheduler.
Each module can be programmed independently. This means that it is possible to remove, replace, upgrade modules, to add new ones or just to check how the information is sent and read.
Support for individually produced functional modules for any purpose.

The event router scheduler may be used in and integrated into any software component based on the modular and functional architecture. Several areas of application are pointed out:
Functional structure for service-oriented integrated devices.
Development tools that automate access to service-oriented devices and whose internal architecture includes these concepts.
Development of virtual software components for environment simulation.
Monitoring of tools and components that collect information from other components.
Support of the development of software agents and multi-agent systems.

The invention at hand consequently deals with an anatomy-like structure for the development of functional and reusable modules of a component as part of a service-oriented automation system. The central focus is on their internal structure and in particular on the mechanism that combines the functional modules and that is called event router scheduler. The event router scheduler may be compared with the nervous system of a living thing in terms of transport/handling of impulses from and to different organs and thus for maintaining the dynamic flow of information. Intelligent behavior may be achieved when these nerves are connected with the “brain” which provides static control based on workflow processes and which is likewise autonomous in order to react to unforeseen events, undocumented situations or internal objectives. Integrated into a service-oriented environment, communication with other components can be achieved only through the provision and request of services in order to realize local and global objectives.

Additional details, advantages and characteristics result not only from the claims, the characteristics to be found therein—individually and/or in combination—but also from the following description of preferred embodiments to be found in the drawings:

Shown are:

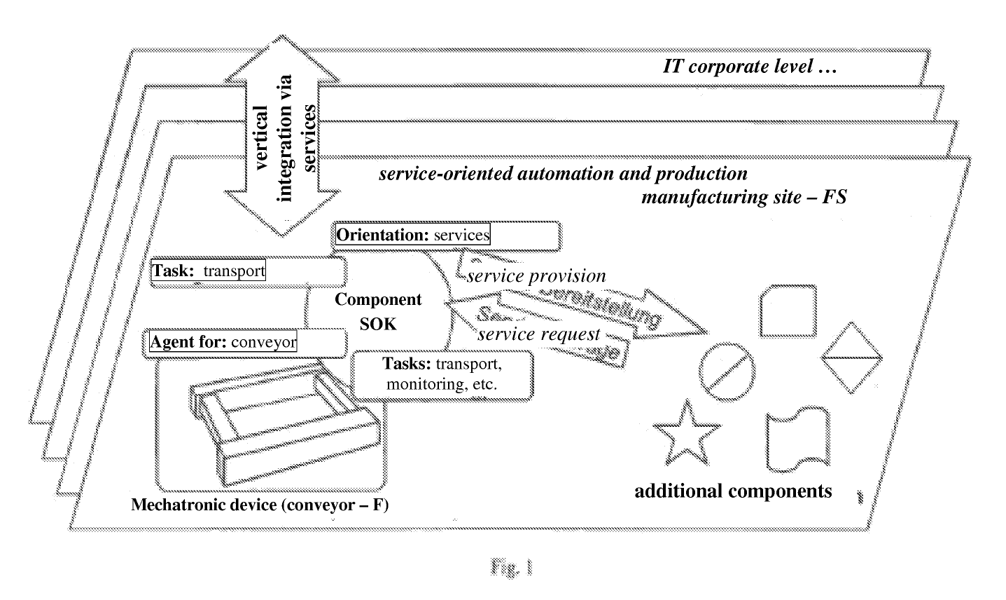

FIG. 1 a schematic representation of a service-oriented automation component of a service-oriented automation and production system;

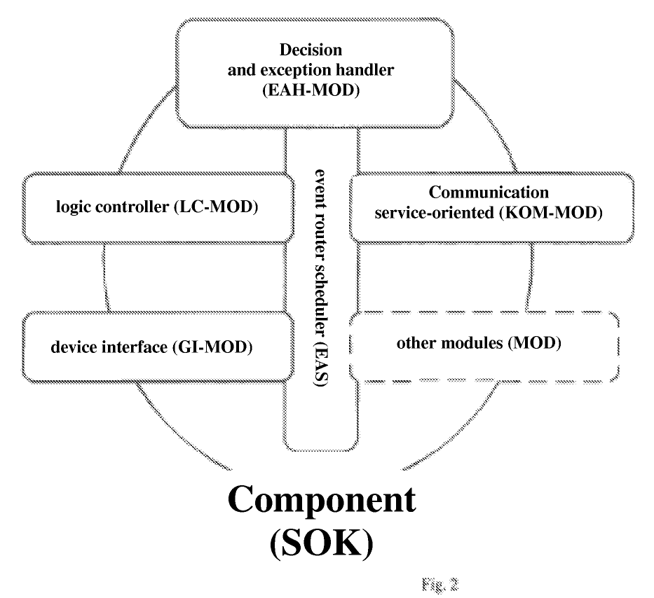

FIG. 2 schematic representation of a modular structure of a service-oriented component;

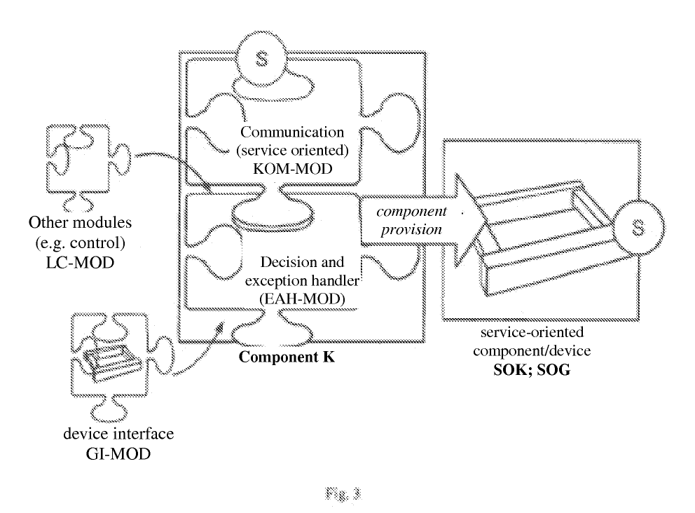

FIG. 3 schematic representation of the composition of a service-oriented component with event router control;

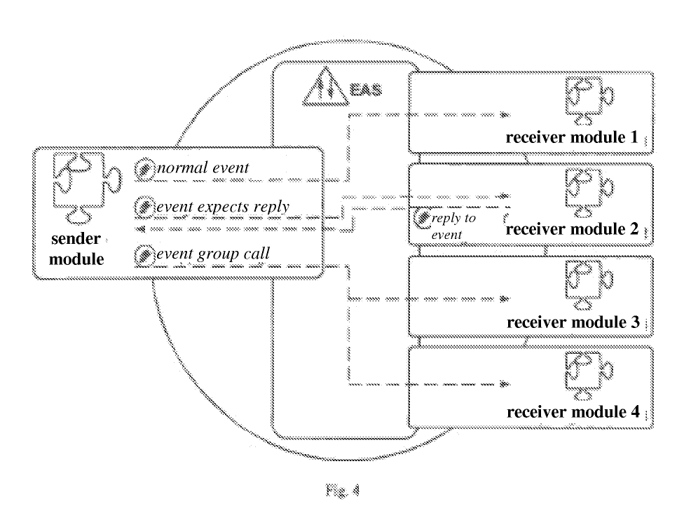

FIG. 4 various types of transmission of event messages by a module via the event router control;

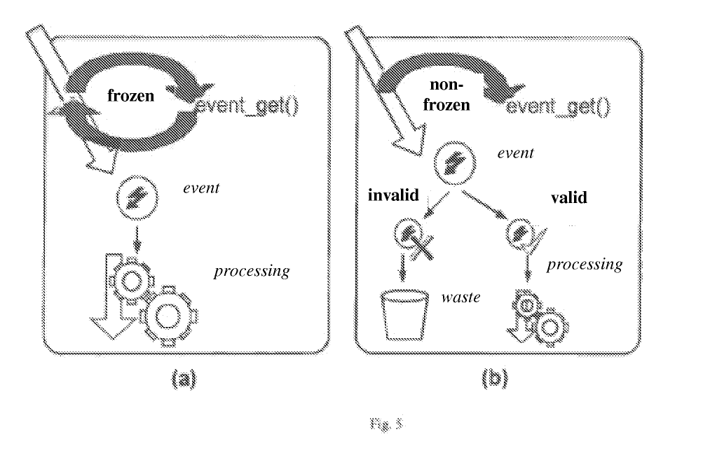

FIGS. 5a, b schematic representation of the reading of an event with a “blocked” module or, respectively, “open” module;

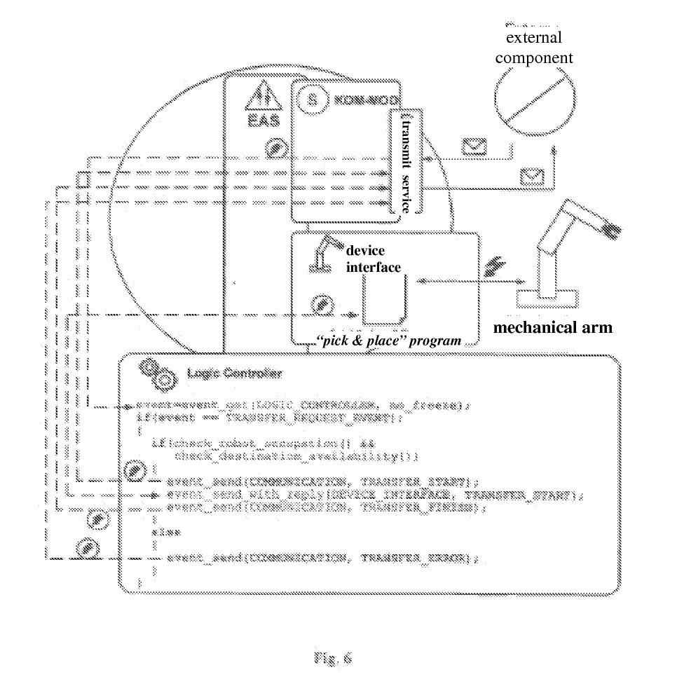

FIG. 6 schematic representation of a service-oriented component of a mechanical arm and its function.

FIG. 1 shows a schematic representation of a service-oriented component (SOK) and its integration into an automation and production environment of a manufacturing site FS. The SOK component shown represents a physical conveyor F and takes over the transport function (task: transportation). Communication with the outside world occurs via services (service orientation) that are capable of requesting or providing services on demand. The integration into the IT environment is also achieved via service orientation. The component comprises a set of functions (tasks) (tasks: transport, supervision, etc.) that can be used as services made available by the components.

An interaction between the components occurs in accordance with the two-way principle in terms of requesting the service and providing the service. It is expected that in production and automation, heterogeneous components collaborate to mutual advantage and to achieve the global objectives. This may be termed “symbiosis,” similar to the interactions between various biological species, however, with the global objective ultimately needing to be taken into account.

In some situations, service-oriented components may be regarded as software agents.

Beyond that, multi-agent systems are of particular interest since these systems bring out the idea of the collaborative agent community in which each of them can take over autonomous actions on their environment or on the system that they represent. On the other hand and contrary to the agent concepts, the true sense of service orientation centers on the feature of offering services and on the necessity of requesting services by a component in the system. The actual architecture, environment and objective of the system are open to the user, and therefore the system can be adapted to different strategies to meet the requirements.

The specification of an internal anatomy of components that simplified their development still remains open. But since service-oriented components are able to carry out different and at times competing activities, it may be helpful to take a functional and independent structure into consideration in favor of reusability and simple development.

Every service-oriented SOK component can be implemented independently and in various ways. The only requirement is that the component offer its functions as services S and that a communication protocol and procedure is to be followed. In order to be able to design and develop these components in a simple yet functional manner, a “framework” similar to an anatomy is proposed.

FIG. 2 shows the schematic structure of an SOK component in an anatomic form comprising several “organs” (functional modules) that are responsible for individual tasks as shown in FIG. 2: logic controller LC-MOD, decision and exception handler EAH-MOD, communication K-MOD, device interface GI-MOD and event router scheduler EAS-MOD. These modules are contained in the control component SOK according to their requirement and possibly implemented using various technologies. It is also possible to develop and integrate other modules MOD for various functionalities if they respect the rules that are [missing part] by the framework for the integration (tasks of the event router scheduler).

The EAS event router scheduler and the communication module KOM-MOD are the kernel modules in order to develop a service-oriented component SOK based on the proposed anatomy. They are responsible for the main framework of the component (event-based inter-module interaction and integration), on the one hand, and external communication with other components (service-oriented inter-component communication). Other modules MOD may be added to the structure in accordance with the component requirements.

Stated more precisely, the communication module KOM-MOD makes the necessary functions available in order to offer services of the associated components and to request services of other components. Other functions include, among other things, discovery and negotiation mechanisms. The remaining modules of the component may use the communication module KOM-MOD for access to these functions through impulses (events) that are provided by the event router module EAS-MOD. As an example, a conveyor belt can provide the service “transfer” in order to actuate the movement of palettes which is controlled by the logic control module LC-MOD and requested by the device interface module GI-MOD. The “transfer” service may be used by other components; however, the component can also request external services itself if they are required (e.g. for a connection with other conveyor belts, it requests the service “transfer” of another conveyor belt).

A suitable technological solution for the implementation of the service-oriented communication modules is the use of web technology, and in particular of web services. Basically, the web service technology is quite simple and was developed in order to move XML (Extended Markup Language) documents between service processes using standard internet protocols. This simplicity enables web services to reach the higher objective of interoperability and, at the same time, means that it is necessary to add other technologies in order to realize complex distributed applications. A profile has been specified to adapt web services to the device level which is known as “device profile for web service (DPWS)”.

The additional modules MOD are briefly described in FIG. 2. The objective is to include the additional modules in order to provide a service-oriented automation component SOK that is an “agent” for any physical equipment with control capability. For example, the resulting component SOK in accordance with FIG. 2 represents a “smart controller” of the conveyor belt device F; by providing several properties such as, for example, control and access via the physical device, the decision capability in unforeseen and undocumented situations and also the possibility of service-oriented communication with other components. Another example is a service-oriented PLC-like controller that can interpret control models (e.g. in IEC61131-3 languages) and that issues necessary commands to other components by requesting the services provided by them. In this case, device interface modules are not necessary since they do not instruct the devices directly.

Finally, the “nervous system” of the “anatomy” represented in FIG. 2 is managed by the event router scheduler EAS. The latter will be explained in detail in the following.

Components and devices that implement several of the represented aspects of service orientation require a uniform anatomy in order to act together with the various function modules (organs) in order to meet the necessary requirements. Other problems may stem from the asynchronously operated modules, possibly data inconsistencies and competing processes/threads. For this purpose a mechanism is proposed that provides an impulse (event) transmittal and control characteristic in order to guide the “impulses” to various modules, thereby facilitating a synchronized interaction between them. The heart of this component is the event router scheduler EAS-MOD.

The EAS-MOD meets the following objectives:
joint event router/control mechanism for the interaction and integration of modules;
providing some transparent functions to form and guide modules;
suitable for software applications developed for conventional PCs as well as for integrated systems;
high performance, in particular in critical situations and targeting real-time application;
use of, for example, C-languages with the objective of balancing performance, portability and characteristics;
safe handling and management of data concurrency;
simple usability through developers in terms of the design of modules and how events are executed.

The function of the EAS-MOD is in some parameters comparable to the nervous system of living beings including humans.

In the case of service-oriented components SOK, the “environment” is registered and manipulated by specific modules such as, for example, communication and device interface modules.

The natural equilibrium of impulses (events) of the individual modules and their integration is achieved with the aid of the event router scheduler module EAS-MOD.

The event router scheduler module EAS is an event handler for real time operated SM, GIM, KM modules of the same application (see FIG. 3). It is like the central piece of a simple puzzle, with the puzzle parts being the various software modules of the same program. It is mostly intended to handle the communication between modules during other activities (“on the fly”); this means that each module can send events to and receive them from all others without having to take care of synchronization, loss of information, data transcription LC-Mod, GI-MOD, KOM-MOD and other things.

A component K is implemented into the corresponding SOK, SOG device or the software application after the required modules have been connected. In FIG. 3, the component K consists of two required modules, namely the event router scheduler module (EAS) and the communication module KOM-MOD but also of a device interface module that is GI-MOD-capable of reading information from the I/O of the appurtenant module or, respectively, of writing to the I/O.

The main characteristic is the provision of an event-based interaction between the functional modules and the corresponding course control of events (see control and course of events as per FIG. 4). From a practical point of view, the internal impulses (events) of the component between its functional modules is managed internally by the event router scheduler. The event router scheduler permits synchronous and asynchronous event requests between all modules which is very important for real-time applications. It also offers several additional procedures for the realization of more complex courses, such as events, that are generated by other events and time-controlled events. In the simplest form, a sender module must send only one event to a specific target (another module) and the event router scheduler routes this to its target. There exist also other options for the sending and processing of events such as, for example, “event expects callback” and “multicast” of an event to several target modules as shown in FIG. 4. An event is a structure with all information that a module needs in order to recognize various possible situations. In addition to the standard information relative to the requested action and the appurtenant parameters, the structure may request a response to the provision of an information or be equipped with an error report receiver, or an event receiver may check whether or not it is a response. It is also recognizable if an event has been sent more than once due to an error.

The event router scheduler control uses lists as means for the transmission and sorting of events between the modules so that the number of events waiting to be processed is limited only by the available storage unit. The event router scheduler control uses several techniques to avoid fragmentation of the storage unit since the generation and deletion of data is a very frequently used function in the modules. In some cases, when the number of events is great, the event router scheduler control offers the opportunity of assigning different priorities to the events. An event sent to a certain module will always be allowed to pass by all waiting events of this module that have a lower priority than the priority of the event being sent.

The system is capable of executing synchronous as well as asynchronous operations, with asynchronous operations being managed by threads. The synchronous operations may be either “frozen” or “non frozen” for the receiver. For example, during the reading of the event, the operation may be a “freeze module” or not. Subsequently, the module will continue normal procedure as shown in FIG. 5a. This is a procedure with very low CPU resource capacity utilization which is particularly suited for integrated devices. However, it does not make sense for real-time multi-tasking modules since this type of module is not supposed to be “frozen”. On the other hand, the “non frozen” event readers will always receive an event. The latter, however, may be an invalid one. An event means that there are no events for the module so that it can continue working on other tasks. If it is a valid event, the module should continue with it. This is shown in FIG. 5b.

Asynchronous event triggering is also possible. In this case, callbacks are used in order to execute this type of operation since it must appear when it is requested. However, the event is not triggered directly for reasons of data protection, and it should occur only when the module activates a MUTEX (mutual exclusion) in order to permit callbacks that may change the data of the module. Each module has a MUTEX for this case.

The remaining blocks as per FIG. 4 are responsible for adjoining tasks of scheduling and routing of events, in particular for the management of the own module and of the other modules. The hardware/software abstraction permits a functional transparency of the system architecture that may be accessed by all modules. Since the event routing scheduler module and other modules are in a multi-functional and competing environment, a special block TDK of the EAS will handle simple thread manipulation and data protection. The block is called threading and data consistency block TDK.

Finally, the block “template/interface for event-based modules” T/I makes a basis available for the generation of functional modules and connects them with the event routing scheduler control. Each module can be programmed independently. This means that it is possible to remove, replace or update it or to add new modules. This makes a program using EAS very flexible. The module ID is the identification of the module and is unambiguous for each module. The other modules must know this variable in order to send an event to a specific module. This is comparable to the code borne by nerves in order to reach certain organs. However, it is also possible to locate a module on the basis of its type such as “controller” or “user interface” since this route is much more practical for a developer in order to reach a module without much information.

FIG. 6 shows the example of the service-oriented component of a mechanical arm and its mode of operation. The functions for the development and operation of the component provided by the framework are shown. The framework consists of the EAS and three modules: the logic controller LC-MOD, the device interface GI-MOD as well as the communication module KOM-MOD.

The invention provides a frame structure or, respectively, a programming scaffolding (framework) for the development of service-oriented automation systems particularly suited for the mechanism of transmission of events between various functional modules that form the components. The adaptation of these “biologically inspired” modular structures makes the design and the development of modules with unambiguous and independent functions possible. The latter, however, are complementary to each other in order facilitate the formation of complex, intelligent and “social” components. The resulting component structure is distinguished by a shortened development time and low effort for the integration into a system.

In summary, it must be noted that the automation and production systems develop into autonomous and collaborative components that apply the idea of business systems. A single member of this system is responsible for various and competing activities, and therefore a specially adapted analysis is required that balances the various requirements. The invention discloses an anatomic structure for the development of functional and reusable modules of service-oriented automation components. The central attention is directed at the internal structure and the mechanism that connects the modules with each other and that is called event router scheduler.

The resulting software automation components are developed in user-specific fashion for various applications based on the inclusion and management of the specialized functional modules and offer the opportunity to work in a service-oriented automation and production environment.

1. Method for controlling an interaction between modules such as communication module (KOM-MOD), control module (LC-MOD), device interface module (GI-MOD) of a service-oriented component (SOK),
characterized in
that the interaction between the modules (KOM-MOD); LC-MOD; GI-MOD) occurs in event-based fashion, with the modules (KOM-MOD); LC-MOD; GI-MOD) being coupled via an event router scheduler module (EAS-MOD) for the provision of an event router scheduler control for an event-based connection and synchronization of the modules (KOM-MOD); LC-MOD; GI-MOD).

2. Method in accordance with claim 1,
characterized in
that the event-based interaction occurs independent of a synchronization between the modules (KOM-MOD); LC-MOD; GI-MOD) as well as independent of loss of information and data transcription.

3. Method in accordance with claim 1 or 2,
characterized in
that the modules (KOM-MOD); LC-MOD; GI-MOD) are coupled with each other and subsequently entered into the service-oriented components (SOK) such as an automation device or software.

4. Method in accordance with one of the preceding claims,
characterized in
that the event messages are stored temporarily in a storage unit according to their priority.

5. Service-oriented hardware and/or software component (SOK) such as an automation device or software application with a modular structure, comprising at least one service-oriented communication module (KOM-MOD), a control module (LC-MOD) as well as a device interface module (GI-MOD),
characterized in
that the service-oriented component (SOK) is equipped with an event routing scheduler module (EAS-MOD) that has a framework for the provision of an event routing scheduler mechanism for an event-based connection and synchronization of the modules (KOM-MOD; LC-MOD; GI-MOD).

6. Service-oriented component in accordance with claim 5,
characterized in
that the service-oriented component (SOK) has multi-threading capabilities.

7. Service-oriented component in accordance with claim 5,
characterized in
that the modules (KOM-MOD; LC-MOD; GI-MOD) are software modules of the same program.

8. Service-oriented component in accordance with one of claims 5-7,
characterized in
that the service-oriented component (SOK) is equipped with a priority-based storage unit for event messages provided with priority.

9. Software component with a computer program equipped with software means for the execution of a procedure in accordance with one of claims 1-8 if the software component is executed in an automation device.
